(19) United States
(12) Patent Application Publication
(10) Pub. No.: US 2020/0183948 A1
(43) Pub. Date: Jun. 11, 2020

(54) PROVISIONING COMPUTE AND DATA RESOURCES WITHIN AN ELASTIC DATA WAREHOUSE SYSTEM

(71) Applicant: Capital One Services, LLC, Mclean, VA (US)

(72) Inventors: Geping Chen, Mclean, VA (US); Hillary McTigue, Haymarket, VA (US); Syed Shamaz Salim, North Potomac, MD (US); Peter Linnehan, Washington, DC (US); Lalit Agarwal, Mclean, VA (US); Nitin Singh, Falls Church, VA (US); Anushiya Balakrishnan, Arlington, VA (US)

(73) Assignee: Capital One Services, LLC, Mclean, VA (US)

(21) Appl. No.: 16/213,298

(22) Filed: Dec. 7, 2018

(51) Int. Cl. G06F 16/25; G06F 9/451; G06F 16/23

(52) U.S. Cl. CPC G06F 16/254; G06F 3/0482; G06F 16/2365; G06F 9/451

(57) ABSTRACT

In one aspect, the present disclosure relates to a method for improvement of provisioning of compute resources among users. The method may include: presenting, on a display of a computing device, a user interface (UI) for provisioning compute resources within an elastic data warehouse system including one or more virtual warehouses; receiving, in response to a user submitting information via the virtual warehouse creation form, a virtual warehouse name, a virtual warehouse specification, and a virtual warehouse approver identifier; sending the virtual warehouse name, the virtual warehouse specification, and the virtual warehouse approver identifier to a provisioning server; receiving from the provisioning server a validation result for the virtual warehouse name, a cost estimate based on the virtual warehouse specification, and a verification result for the virtual warehouse approver identifier; and displaying, on the virtual warehouse creation form, the validation result, the cost estimate, and the verification result.

### BACKGROUND

Public cloud platforms offer virtually unlimited compute and storage resources on demand. At the same time, the Software-as-a-Service (SaaS) model used in such public cloud platforms brings enterprise-class systems to users who previously could not afford such systems due to their cost and complexity. Traditional data warehousing systems are struggling to fit into this new environment. First, such systems have been designed for fixed resources and are thus unable to leverage the cloud's elasticity. Second, the dependence of such systems on complex Extract-Transform-Load (ETL) pipelines and physical tuning is at odds with the flexibility and freshness requirements of the cloud's new types of semi-structured data and rapidly evolving workloads. Accordingly, current data warehouse systems do not have a method for provisioning of resources in a consistent and well-managed way.

### SUMMARY

According to one aspect of the present disclosure, a method may perform improvement of provisioning of compute resources among multiple users. The method may comprise: presenting, on a display of a computing device, a user interface (UI) for provisioning compute resources within an elastic data warehouse system comprising one or more virtual warehouses; receiving, in response to a user submitting information via the virtual warehouse creation form, a virtual warehouse name, a virtual warehouse specification (e.g. a size of the virtual warehouse), and a virtual warehouse approver identifier; sending the virtual warehouse name, the virtual warehouse specification, and the virtual warehouse approver identifier to a provisioning server; receiving from the provisioning server a validation result for the virtual warehouse name, a cost estimate based on the virtual warehouse specification, and a verification result for the virtual warehouse approver identifier; and displaying, on the virtual warehouse creation form, the validation result, the cost estimate, and the verification result. In some configurations, the UI includes a virtual warehouse control menu and a virtual warehouse creation form. In some configurations, the provisioning server uses the virtual warehouse name, the virtual warehouse specification, and the virtual warehouse approver identifier to provision the compute resources within the elastic data warehouse system.

In some embodiments, receiving the validation result for the virtual warehouse name, the cost estimate based on the virtual warehouse specification, and the verification result for the virtual warehouse approver identifier is asynchronous. In some embodiments, the UI further comprises a request submission control, and wherein the method further comprises sending a virtual warehouse request to the provisioning server in response to the user activating the request submission control. In some embodiments, the virtual warehouse control menu comprises a request listing control, and wherein the method further comprises, in response to the user activating the request listing control, presenting a list of virtual warehouses of the user that are pending for approval by their designated virtual warehouse approvers. In some embodiments, the virtual warehouse control menu comprises a virtual warehouse listing control, and wherein the method further comprises, in response to the user activating the virtual warehouse listing control, presenting a list of virtual warehouses of the user that have been approved by their designated virtual warehouse approvers. In some embodiments, the method includes presenting, on the display of the computing device, the UI that further comprises a collaborative project control menu and a collaborative project creation form, each for a collaborative project of two or more users of the compute resources; receiving, in response to a user submitting information via the collaborative project creation form, a collaborative project name, a collaborative project data type, and a collaborative project approver identifier; sending the collaborative project name, the collaborative project data type, and the collaborative project approver identifier to the provisioning server; receiving from the provisioning server a project validation result for the collaborative project name, a project authorization result based on the collaborative project data type, and a project verification result for the collaborative project approver identifier; and displaying, on the virtual warehouse creation form, the project validation result, the project authorization result, and the project verification result. In some embodiments, the UI further comprises a project request submission control, and wherein the method further comprises sending a collaborative project request to the provisioning server in response to the user activating the project request submission control. In some embodiments, the collaborative project control menu comprises a project request listing control, and wherein the method further comprises, in response to the user activating the project request listing control, presenting a list of collaborative projects of the user that are pending for approval by their designated collaborative project approvers. In some embodiments, the collaborative project control menu comprises a collaborative project listing control, and wherein the method further comprises, in response to the user activating the collaborative project listing control, presenting a list of collaborative projects of the user that have been approved by their designated collaborative project approvers.

According to another aspect of the present disclosure, a method may be used for improving provisioning of compute resources among multiple users. The method may comprise: receiving, from a computing device configured for provisioning compute resources within an elastic data warehouse system comprising one or more virtual warehouses, a virtual warehouse name, a virtual warehouse specification, and a virtual warehouse approver identifier; determining, by a validation module, a validation result for the virtual warehouse name by analyzing the virtual warehouse name for its conformance to a naming standards ruleset, wherein the validation result comprises valid and invalid; determining, by an estimation module, a cost estimate based on the virtual warehouse specification by using the virtual warehouse specification in a cost estimator model; determining, by a verification module, a verification result for the virtual warehouse approver identifier by comparing the virtual warehouse approver identifier to entries in a provisioning approver identifier list, wherein the verification result comprises verified and unverified; sending the validation result, the cost estimate, and the verification result to the computing device; and provisioning the compute resources within the elastic data warehouse system by using the virtual warehouse name, the virtual warehouse specification, and the virtual warehouse approver identifier.

In some embodiments, receiving of the virtual warehouse name, the virtual warehouse specification, and the virtual warehouse approver identifier, or the sending of the validation result, the cost estimate, and the verification result is asynchronous. In some embodiments, the method includes, in response to receiving a virtual warehouse request from the computing device, sending a virtual warehouse approval request to an approver computing device associated with a virtual warehouse approver designated by the virtual warehouse approver identifier. In some embodiments, the method includes receiving an approval from the approver computing device before provisioning the compute resources within the elastic data warehouse system. In some embodiments, the method includes monitoring an actual cost and an actual workload of a virtual warehouse of the elastic data warehouse system. In some embodiments, the method includes, in response to receiving a request listing inquiry from the computing device, sending to the computing device a list of virtual warehouses of the user that are pending for approval by their designated virtual warehouse approvers. In some embodiments, the method includes, in response to receiving a virtual warehouse listing request from the computing device, sending to the computing device a list of virtual warehouses of the user that have been approved by their designated virtual warehouse approvers. In some embodiments, the method includes receiving, from the computing device, a collaborative project name, a collaborative project data type, and a collaborative project approver identifier, each for a collaborative project of two or more users of the compute resources; determining, by a validation module, a project validation result for the collaborative project name by analyzing the collaborative project name for its conformance to a project naming standards ruleset, wherein the project validation result comprises valid and invalid; determining, by an estimation module, a project authorization result based on the collaborative project data type by comparing the collaborative project data type with a list of permitted data types for project users of the collaborative project; determining, by a verification module, a project verification result for the collaborative project approver identifier by comparing the collaborative project approver identifier to entries in a project provisioning approver identifier list, wherein the project verification result comprises verified and unverified; and sending the project validation result, the project authorization result, and the project verification result to the computing device. In some embodiments, the method includes assigning an expiration date for the collaborative project. In some embodiments, the method includes assigning a project leader for the collaborative project.

According to another aspect of the present disclosure, a system performs improving provisioning of compute resources among multiple users. The system may comprise: a database, one or more processors, a managing module, a validation module, an estimation module, and a verification module. The managing module receives one or more input parameters, sends the one or more input parameters to one or more modules (e.g. validation module, the estimation module, and the verification module), receives one or more output parameters from the one or more modules, sends the output parameters to the computing device, and provisions the compute resources within the elastic data warehouse system by using the output parameters. The validation module receives a virtual warehouse name as an input parameter from the managing module, determines the validation result for the virtual warehouse name by analyzing the virtual warehouse name for its conformance to a naming standards ruleset; and sends the validation result as an output parameter to the managing module. The estimation module receives a virtual warehouse specification as an input parameter from the managing module; determines the cost estimate based on the virtual warehouse specification by using the virtual warehouse specification in a cost estimator model; and sends the cost estimate as an output parameter to the managing module. The verification module receives a virtual warehouse approver identifier as an input parameter from the managing module; determines the verification result for the virtual warehouse approver identifier by comparing the virtual warehouse approver identifier to entries in a provisioning approver identifier list, and sends the verification result as an output parameter to the managing module.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 is a block diagram of a system for improving provisioning of compute and data resources among multiple users, according to some embodiments of the present disclosure.

FIG. 2 is a flow diagram showing processing that may occur within the system of FIG. 1, according to some embodiments of the present disclosure.

FIG. 3 is a flow diagram showing processing that may occur within the system of FIG. 1, according to some embodiments of the present disclosure.

FIGS. 4, 5, 6, 7 and 8 illustrate user interfaces generated for improving provisioning of compute and data resources among multiple users by the system of FIG. 1, according to some embodiments of the present disclosure.

FIG. 9 is a block diagram of an example user device using the process described herein, according to an embodiment of the present disclosure.

The drawings are not necessarily to scale, or inclusive of all elements of a system, emphasis instead generally being placed upon illustrating the concepts, structures, and techniques sought to be protected herein.

### DETAILED DESCRIPTION

In a conventional cloud-based analytic environment, where users can provision their own resources such as compute and storage to analyze and share their data, there does not exist a well-managed, cost-effective, secure, and yet user-friendly platform environment for the users in order to enable users manage their own cloud analytic resources such as compute and storage. In contrast, according to one aspect, the present disclosure relates to a system for provisioning of compute and data resources among multiple users in a consistent and well-managed way suitable for a large enterprise. In one example, the system may perform provisioning of compute (i.e. warehouses) and data (i.e. schema) resources by: enforcing naming, tagging resources for reporting and billing, estimating cost, handling all necessary notifications, enforcing executive approval of the costs, managing the workflow of request, approval, and creation, and enforcing the implementation of cost-saving features (e.g. Auto Suspend/Resume) of the system. In some aspects, the disclosed system allows a set of users to manage their own warehouses in a consistent way by: monitoring the cost of their warehouses, monitoring the workload of their warehouses, maintaining owners and/or users of their warehouses, and resizing and dropping the warehouses of owners/users based on actual usage. In a different aspect, the system disclosed herein allows shared project spaces (referred to as ‘schema’ or ‘collaboration schema’) to be provisioned by a set of users in a controlled and consistent way by enforcing naming and tagging of the collaboration schema, logging the sensitive data types to be put into the collaboration schema, enforcing executive approval of the creation and managing the work flows of request, approval, and creation, logging and reporting all collaboration schemas to public. In some configurations, the system assigns for each of the collaborative schemas at least one of a project leader. In yet another aspect, the system disclosed herein allows a set of users to manage their collaboration schema in a controlled and consistent way by maintaining owners and users of the schema, validating the user's necessary sensitive data roles before the user is granted usage to the schema, and managing notifications. In one aspect, the system disclosed herein is an elastic data warehouse system in which storage and compute and data resources can be scaled independently and seamlessly, without impact on data availability or performance of concurrent queries.

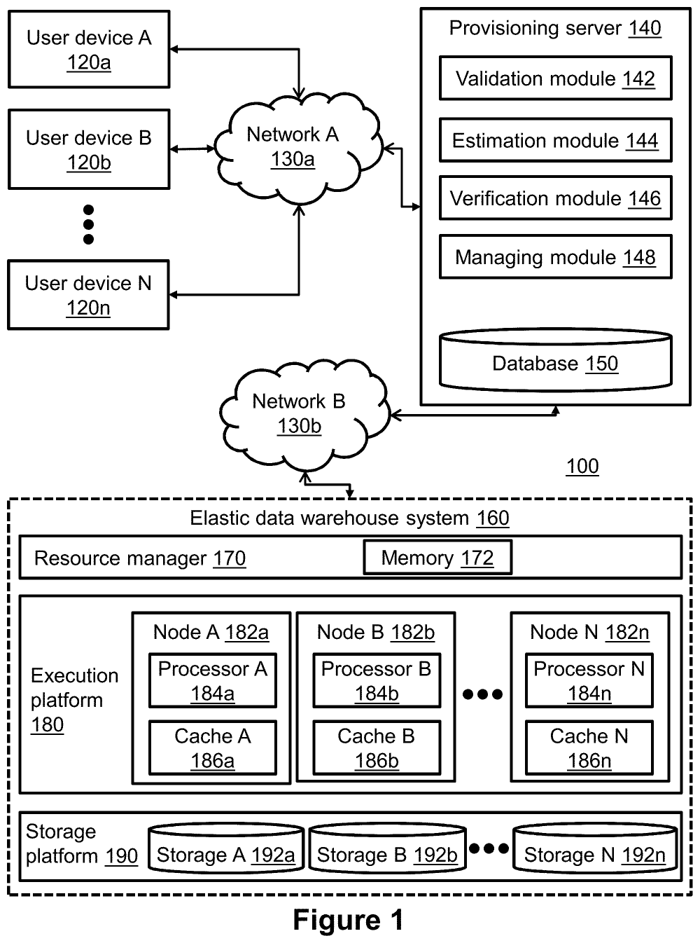

As described below in conjunction with FIGS. 1-9, in one aspect, the present disclosure relates to a method comprising: presenting, on a display of a computing device, a user interface (UI) for provisioning compute and data resources within an elastic data warehouse system having one or more virtual warehouses; receiving, in response to a user submitting information via the virtual warehouse creation form, a virtual warehouse name, a virtual warehouse specification (e.g. a size of the virtual warehouse), and a virtual warehouse approver identifier; sending the virtual warehouse name, the virtual warehouse specification, and the virtual warehouse approver identifier to a provisioning server; receiving from the provisioning server a validation result for the virtual warehouse name, a cost estimate based on the virtual warehouse specification, and a verification result for the virtual warehouse approver identifier; and displaying, on the virtual warehouse creation form, the validation result, the cost estimate, and the verification result.

In some aspects, the disclosed system can be a single-page application service management and implementation tool. The disclosed system can run on top of a third-party Service (the Service) and can also enforces a subset of Service controls as defined by the Enterprise (the Enterprise) employing the Service. The disclosed system can provide the Enterprise a system of record for the Service by handling a number of functions, including, but not restricted to, an intake process for Service specific resource requests as required by the Enterprise, an Enforcement and automated assignment of Enterprise required Service resource meta-data, an Enterprise defined approval management for requests requiring approval, an Automated resource request implementation on the Service, Views providing request information and request status, User management for the Service resources as defined by the Enterprise, a notification service that coordinates and alerts.

In some aspects, the disclosed system can take Enterprise specific requirements for the Service and implement the Enterprise requirements through a browser-based graphical user interface (GUI) and back-end business logic (business logic). The business logic can enforce Enterprise specific governance and controls ensuring that all requests are only implemented if valid and approved. The Enterprise specific business logic can be applied to Service resource requests, approvals, implementation, and resource user management.

In some aspects, the disclosed system can provide an abstraction layer for the Service through the GUI. The disclosed system can display relevant information and controls to authenticated and authorized Enterprise users. All communications occurring through the disclosed tool between Enterprise participants can be automated and handled leveraging an Enterprise email system.

### Applications

In one aspect, the present disclosure enforces executive level approval of budgets for provisioning resources in a data warehousing system. In another aspect, the present disclosure provides recommendation to downsize/upsize compute and data resources and storage in a data warehousing system based on actual usage of the compute and data resources.

In another aspect, the present disclosure maintains a system of record for requested resources in the data warehousing system. In another aspect, the present disclosure enforces and assigns all required data warehouse resource specifications in the data warehousing system. In another aspect, the present disclosure maintains notifications and a system of record (i.e. approval management) for resources requiring approval. In another aspect, the present disclosure implements approved requested resources using automation. In one final aspect, the present disclosure provides aggregate views of request data and status.

### System Architecture

FIG. 1 is a block diagram of a system 100 for improving provisioning of compute and data resources among multiple users, according to some embodiments of the present disclosure. The system environment 100 shown by FIG. 1 comprises one or more user devices 120, a network 130a, a network 130b, a provisioning server 140, and an elastic data warehouse (EDW) system 160. In alternative configurations, different and/or additional components may be included in the system 100. The embodiments described herein can be adapted to data warehouse systems that are not elastic.

The user devices 120 are one or more computing devices capable of receiving user input as well as transmitting and/or receiving data via the network 130a. In one embodiment, a user device 120 is a conventional computer system, such as a desktop or laptop computer. Alternatively, a user device 120 may be a device having computer functionality, such as a personal digital assistant (PDA), a mobile telephone, a smartphone or another suitable device. A user device 120 is configured to communicate via the network 130a. In one embodiment, a user device 120 executes an application allowing a user of the user device 120 to send a virtual warehouse name, a virtual warehouse specification, and a virtual warehouse approver identifier to the provisioning server 140. For example, a user device 120 executes a browser application to enable communication of the virtual warehouse name, the virtual warehouse specification, and the virtual warehouse approver identifier between the user device 120 and the provisioning server 140 via the network 130a. In another embodiment, a user device 120 interacts with the provisioning server 140 through an application programming interface (API) running on a native operating system of the user device 120a, such as IOS® or ANDROID™.

The user devices 120 are configured to communicate via the network 130a, which may include any combination of local area and/or wide area networks, using both wired and/or wireless communication systems. In one embodiment, the network 130a uses standard communications technologies and/or protocols. For example, the network 130a includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 130a include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 130a may be represented using any suitable format, such as hypertext markup language (HTML) or extensible markup language (XML). In some embodiments, all or some of the communication links of the network 130a may be encrypted using any suitable technique or techniques. The network 130b is an embodiment of the network 130a. The provisioning server 140 is coupled to the elastic data warehouse system 160 through the network 130b.

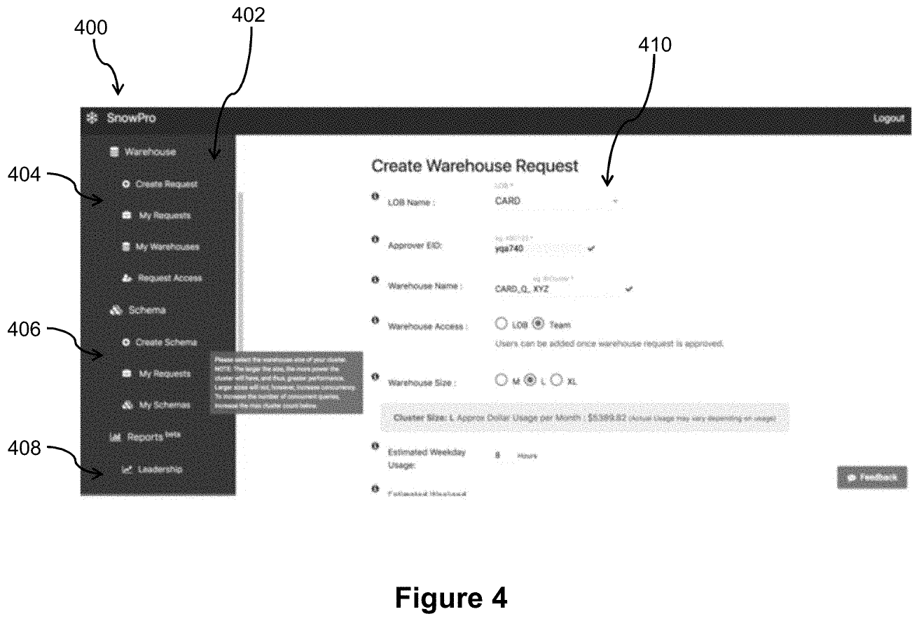

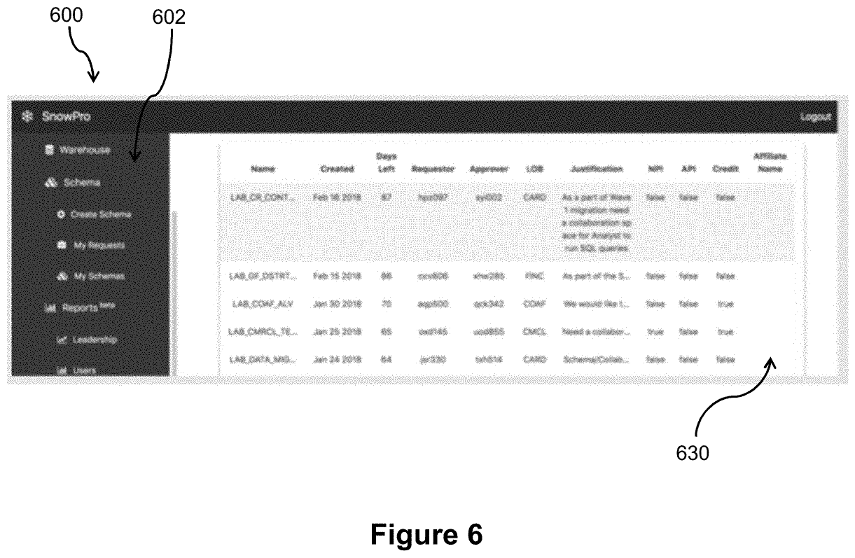

During typical operation, the provisioning server 140 processes multiple queries (or requests) received from any of the user devices 120a and 120b. For example, the provisioning server 140 allows one or more user devices (e.g. 120a and 120b) to request access to a specific warehouse of the elastic data warehouse system 160. In some embodiments, the provisioning server 140 receives from the user device 120a a virtual warehouse name, a virtual warehouse specification, and a virtual warehouse approver identifier. The provisioning server 140 sends these queries to the resource manager 170 through the network 130b to determine when and how to execute the queries. As described below in conjunction with FIG. 4, the provisioning server 140 presents a user interface having a virtual warehouse control menu and a virtual warehouse creation form which receives a virtual warehouse name (e.g. CARD_Q_XYZ), a virtual warehouse specification (e.g. Large), and a virtual warehouse approver identifier (e.g. yqa740) from a user device 120a. As described below in conjunction with FIGS. 6-8, the provisioning server 140 presents a user interface on a user device 130a with the validation result, the cost estimate, and the verification result.

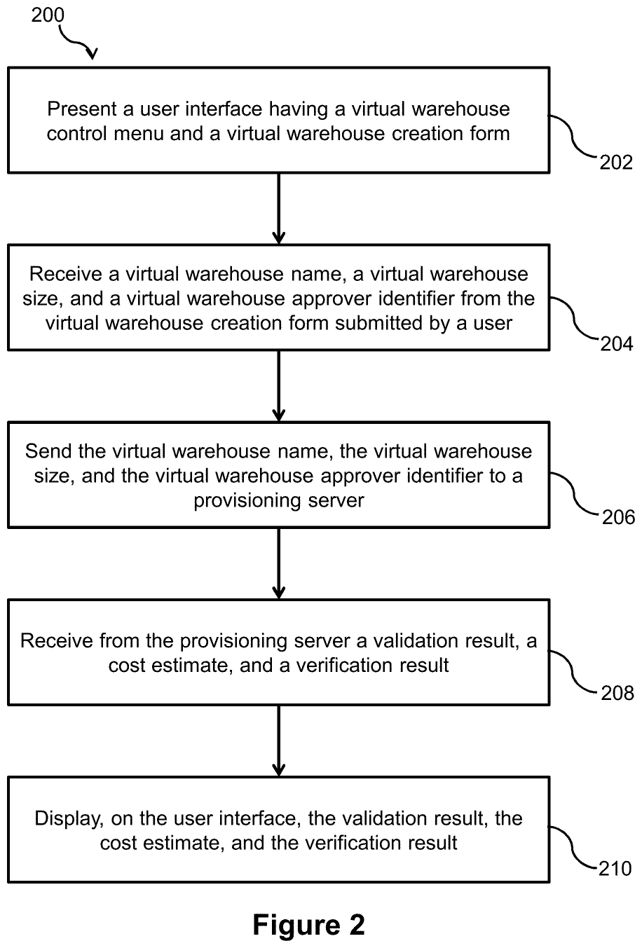

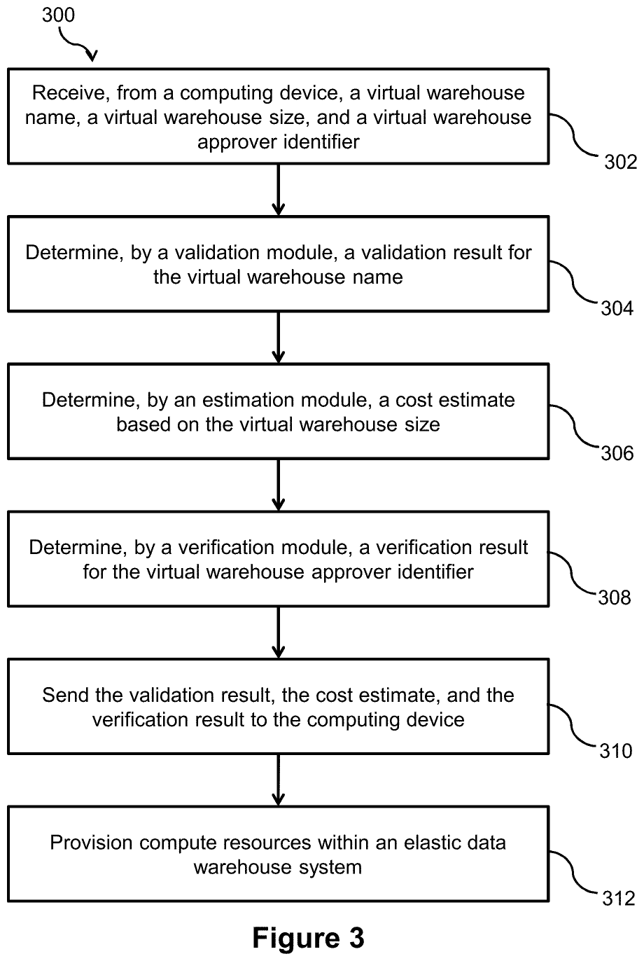

As shown in FIG. 1, the provisioning server 140 can include a validation module 142, an estimation module 144, a verification module 146, a managing module 148, and a database 150. The validation module 142 can determine a validation result for the virtual warehouse name received from a user device. The estimation module 144 can determine a cost estimate based on the virtual warehouse specification. The verification module 146 can determine a verification result for the virtual warehouse approver identifier. The managing module 148 can perform a provisioning of compute resources (i.e. warehouses) within an elastic data warehouse system. The database 150 can be a repository for storing the validation result, the cost estimate, and the verification result. More details about the above components of the provisioning server 140 are described below in conjunction with FIGS. 2-3.

In some embodiments, the provisioning server 140 receives one or more parameters from the managing module 148, sends the received parameters to the user device 120a, and provisions the compute resources within the elastic data warehouse system 160 by using the parameters. For example, the validation module 142 receives a virtual warehouse name (e.g. CARD_Q_XYZ) as an input from the managing module 148, determines the validation result for the virtual warehouse name by analyzing the virtual warehouse name for its conformance to a naming standards ruleset, and sends the validation result for the virtual warehouse name to the managing module 148. The estimation module 144 can receive a virtual warehouse specification (e.g. Large) from the managing module 148, determine the cost estimate based on the virtual warehouse specification by using the virtual warehouse specification in a cost estimator model, and send the cost estimate as an output parameter to the managing module 148. For example, the estimated monthly warehouse cost is based on the following data collected from the requester as part of the request: estimated weekday usage (in hours), estimated weekend usage (in hours), warehouse specification, minimum running cluster count, and maximum running cluster count. The above inputs are then used in a credit estimation algorithm whose output is multiplied by the current cost per credit rate. The verification module 146 can receive a virtual warehouse approver identifier (e.g. yqa740) from the managing module 148, determine the verification result for the virtual warehouse approver identifier by comparing the virtual warehouse approver identifier to entries in a provisioning approver identifier list (e.g. qck342, uod855, txtd14, etc.), and send the verification result as an output parameter to the managing module 148. In some configurations, the provisioning server 140 receives the validation result for the virtual warehouse name, determines the cost estimate based on the virtual warehouse specification, and determines the verification result for the virtual warehouse approver identifier in an asynchronous fashion.

The elastic data warehouse (EDW) system 160 can be a data processing platform that provides a flexible and scalable data warehouse. In some embodiments, the EDW system 160 leverages a cloud infrastructure that supports cloud-based storage resources, computing resources, and the like. Example cloud-based storage resources offer significant storage capacity available on demand at a low cost. Further, these cloud-based storage resources may be fault-tolerant and highly scalable, which can be costly to achieve in private data storage systems. Example cloud-based computing resources are available on-demand and may be priced based on actual usage levels of the resources. Typically, the cloud infrastructure is dynamically deployed, reconfigured, and decommissioned in a rapid manner. The EDW system 160 shown in FIG. 1 includes a resource manager 170, a memory 172, an execution platform 180, and a storage platform 190. In other embodiments, the EDW system 160 may include additional, fewer, or different components for various applications. Conventional components such as network interfaces, security functions, load balancers, failover servers, management and network operations consoles, and the like are not shown so as to not obscure the details of the system architecture.

The resource manager 170 can provide various services and functions that support the operation of all systems and components within the EDW system 160. The resource manager 170 can be coupled to a memory 172, which can be associated with the entirety of data stored throughout the EDW system 160. In some embodiments, the memory 172 includes a summary of data stored in remote data storage systems as well as data available from a local cache. Additionally, the memory 172 may include information regarding how data is organized in the remote data storage systems and the local caches. The memory 172 allows systems and services to determine whether a piece of data is to be accessed without loading or accessing the actual data from a storage device. The resource manager 170 can be further coupled to an execution platform 180, which provides multiple computing resources that execute various data storage and data retrieval tasks.

As shown in FIG. 1, the execution platform 180 can include multiple virtual warehouses. Each virtual warehouse can include one or more execution nodes 182a that each include a processor 184a and a cache 186a. Each virtual warehouse can be capable of executing multiple queries (and other tasks) in parallel by using the multiple execution nodes 182a and 182b. As discussed herein, the execution platform 180 can add new virtual warehouses and drop existing virtual warehouses in real time based on the current processing needs of the systems and users. This flexibility allows execution platform 180 to quickly deploy large amounts of computing resources when needed without being forced to continue paying for those computing resources when they are no longer needed. All virtual warehouses can access data from any data storage device (e.g., any storage device in storage platform 190). Although each virtual warehouse shown in FIG. 1 includes a single execution node, a particular virtual warehouse may include any number of execution nodes. Further, the number of execution nodes in a virtual warehouse is dynamic, such that new execution nodes are created when additional demand is present, and existing execution nodes are deleted when they are no longer necessary.

The execution platform 180 can be coupled to multiple data storage devices, such as 192a, and 192b, that are part of a storage platform 190. The execution platform 180 can be capable of communicating with any number of data storage devices. In some embodiments, the data storage devices 192a and 192b are cloud-based storage devices located in one or more geographic locations. For example, the data storage devices 192a and 192b may be part of a public cloud infrastructure or a private cloud infrastructure. Data storage devices 192a and 192b may be hard disk drives (HDDs), solid state drives (SSDs), storage clusters, Amazon S3™ storage systems or any other data storage technology. Additionally, the storage platform 190 may include distributed file systems (such as Hadoop Distributed File Systems (HDFS)), object storage systems, and the like.

Each virtual warehouse can be capable of accessing any of the data storage devices 192a and 192b shown in FIG. 1. Thus, virtual warehouses are not necessarily assigned to a specific data storage device 192a and 192b and, instead, can access data from any of the data storage devices 192a and 192b. Similarly, each of the execution nodes shown in FIG. 1 can access data from any of the data storage devices 192a and 192b. In some embodiments, a particular virtual warehouse or a particular execution node may be temporarily assigned to a specific data storage device, but the virtual warehouse or execution node may later access data from any other data storage device. Each execution node 182a can be associated with processing one or more data storage and/or data retrieval tasks. For example, a particular virtual warehouse may handle data storage and data retrieval tasks associated with a particular user or customer. In other implementations, a particular virtual warehouse may handle data storage and data retrieval tasks associated with a particular data storage system or a particular category of data.

In some embodiments, the execution nodes 182a and 182b shown in FIG. 1 can be stateless with respect to the data the execution nodes are caching. For example, the execution nodes 182a and 182b do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes 182a and 182b shown in FIG. 1 each include one data cache and one processor, alternate embodiments may include execution nodes containing any number of processors and any number of caches. Additionally, the caches may vary in specification among the different execution nodes. The caches shown in FIG. 1 store, in the local execution node, data that was retrieved from one or more data storage devices in the storage platform 190. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes which is significantly faster and avoids the bottleneck problem discussed above.

In some embodiments, the caches are implemented using high-speed memory devices that provide fast access to the cached data. Each cache can store data from any of the storage devices in the storage platform 190. Further, the cache resources and computing resources may vary between different execution nodes. For example, one execution node may contain significant computing figuration and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data.

In some embodiments, the cache resource (e.g. cache 186a) and the computing resource (e.g. processor 184a) associated with a particular execution node (e.g. node 182a) are determined when the execution node (e.g. node 182a) is created, based on the expected tasks to be performed by the virtual warehouses. Additionally, the cache resources and computing resources associated with a particular execution node may change over time based on changing tasks performed by the execution node 182a. For example, a particular execution node 182a may be assigned more processing resources if the tasks performed by the execution node become more processor intensive. Similarly, an execution node 182b may be assigned more cache resources if the tasks performed by the execution node require a larger cache capacity.

In some embodiments, the system 100 may receive an approval from the approver computing device before provisioning the compute and data resources within the elastic data warehouse system 160. In some embodiments, the system 100 monitors an actual cost and an actual workload of a virtual warehouse of the elastic data warehouse system 160. In some embodiments, in response to receiving a request listing inquiry from the user device 120, the system 160 sends to the user device 120 a list of virtual warehouses of the user that are pending for approval by their designated virtual warehouse approvers. In some embodiments, in response to receiving a virtual warehouse listing request from the user device 120, the system 100 sends to the user device 120 a list of virtual warehouses of the user that have been approved by their designated virtual warehouse approvers.

FIG. 2 is a flow diagram 200 showing processing that may occur within the system 100 of FIG. 1, according to some embodiments of the present disclosure. The flow diagram 200 of FIG. 2 may be performed by the system 100. Other entities may perform some or all of the steps of the process in other embodiments. Likewise, embodiments may include different and/or additional steps, or perform the steps in different orders.

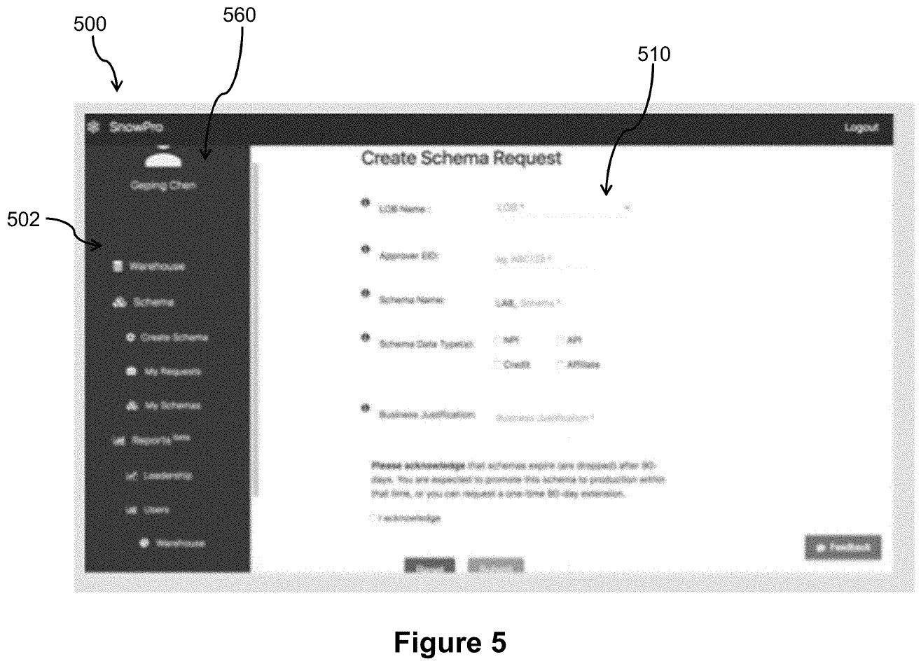

The system 100 can present 202 a user interface (UI) having a virtual warehouse control menu and a virtual warehouse creation form. In some embodiments, as described below in conjunction with FIG. 4 and FIG. 5, the UI includes a collaborative project control menu and a collaborative project creation form, each for a collaborative project of two or more users of the compute resources. The UI may include a project request submission control. The collaborative project control menu may include a project request listing control.

The system 100 can receive 204 a virtual warehouse name, a virtual warehouse specification, and a virtual warehouse approver identifier from the virtual warehouse creation form submitted by a user. In some embodiments, the system 100 receives, in response to a user submitting information via the collaborative project creation form, a collaborative project name, a collaborative project data type, and a collaborative project approver identifier.

The system 100 can send 206 the virtual warehouse name, the virtual warehouse specification, and the virtual warehouse approved identifier to a provisioning server. In some embodiments, the system 100 sends the collaborative project name, the collaborative project data type, and the collaborative project approver identifier to the provisioning server 140. In some embodiments, the system 100 sends a collaborative project request to the provisioning server 140 in response to the user activating the project request submission control in the user interface.

The system 100 can receive 208 from the provisioning server a validation result, a cost estimate, and a verification result. In some embodiments, the system 100 receives from the provisioning server 140 a project validation result for the collaborative project name, a project authorization result based on the collaborative project data type, and a project verification result for the collaborative project approver identifier.

The system 100 can display 210 on the user interface the validation result, the cost estimate, and the verification result. In some embodiments, the system 100 displays, on the virtual warehouse creation form of the user interface, the project validation result, the project authorization result, and the project verification result.

FIG. 3 is a flow diagram 300 showing processing that may occur within the system 100 of FIG. 1, according to some embodiments of the present disclosure. The flow diagram 300 of FIG. 3 may be performed by the system 100. Other entities may perform some or all of the steps of the process in other embodiments. Likewise, embodiments may include different and/or additional steps, or perform the steps in different orders.

The system 100 can receive 302 from a computing device a virtual warehouse name, a virtual warehouse specification, and a virtual warehouse approver identifier. In some embodiments, the system 100 receives, from the user device 130, a collaborative project name, a collaborative project data type, and a collaborative project approver identifier, each for a collaborative project of two or more users of the compute resources. In some embodiments, in response to receiving a virtual warehouse from the computing device, the system 100 sends a virtual warehouse approval request to an approver computing device associated with a virtual warehouse approver designated by the virtual warehouse approver identifier.

The system 100 can determine 304 a validation result for the virtual warehouse name. In some embodiments, the system 100 determines, by the validation module 142, a project validation result for the collaborative project name by analyzing the collaborative project name for its conformance to a project naming standards ruleset. Names are considered ‘taken’ (i.e. cannot be used in a new request) if the name is already being used by an existing resource or if the name is part of a pending (i.e. not approved or rejected) request. The project validation result may be valid or invalid.

The system 100 can determine 306 a cost estimate based on the virtual warehouse specification. In some embodiments, the system 100 determines, by the estimation module 144, a project authorization result by comparing the collaborative project data type with a list of permitted data types (e.g. NPI, Credit, API, Affiliate, etc.) for project users of the collaborative project. Requesters are required to indicate the type of data a collaborative project will use. SnowPro maintains a mapping between the type data and the Enterprise specific roles that can access that type of data. When users are added, the disclosed system can check the user's current roles against the roles necessary to access the type of data associated with a schema. If the user does not have a necessary role for the type of data in the collaborative resource, the user is warned.

The system 100 can determine 308 a verification result for the virtual warehouse approved identifier. In some embodiments, the system 100 determines, by the verification module 146, a project verification result for the collaborative project approver identifier by comparing the collaborative project approver identifier to entries in a project provisioning approver identifier list. The project verification result may be verified or unverified.

The system 100 can send 310 the validation result, the cost estimate, and the verification result to the computing device. In one example, the managing module 148 retrieves the validation result, the cost estimate, and the verification results stored in the database 150, and sends them to the user device 120a.

The system 100 can provision 312 the compute resources within an elastic data warehouse system. In some embodiments, the system 100 performs, by the managing module 148, a provisioning of compute resources within the elastic data warehouse system 160.

FIG. 4 illustrates a user interface 400 generated for creating a warehouse request by the system 100 of FIG. 1, according to some embodiments of the present disclosure. The user interface 400 can include a virtual warehouse control menu 402 and a virtual warehouse creation form 404. The user of the user device 120a can send a virtual warehouse request to the provisioning server 140 when the user activates a request submission control of the virtual warehouse creation form 404.

The virtual warehouse control menu 402 can include a request listing control. When the user of the user device 120a activates the request listing control, the system 100 can present a list of virtual warehouses of the user that are pending for approval by their designated virtual warehouse approvers. The virtual warehouse control menu 402 also can include a virtual warehouse listing control. When the user of the user device 120a activates the virtual warehouse listing control, the user interface 400 can present a list of virtual warehouses of the user that have been approved by their designated virtual warehouse approvers. As shown in FIG. 4, the user interface 400 generated for creating the warehouse request can allow the user device 120a to input the virtual warehouse name (e.g. CARD_Q_XYZ), the virtual warehouse specification (e.g. Large), and the virtual warehouse approver identifier (e.g. yqa740).

FIG. 5 illustrates a user interface 500 of a user interface generated for creating a schema request by the system 100 of FIG. 1, according to some embodiments of the present disclosure. The user interface 500 can include a project request submission control 502 that sends a collaborative project request to the provisioning server 140 when the user of the user device 120a activates the project request submission control 502. The project request submission control 502 can allow an user to input a collaborative project name, a collaborative project data type, and a collaborative project approver identifier for creating a collaborative project.

As shown in FIG. 5, the collaborative project control menu 504 can include a project request listing control. When the user of the user device 120a activates the project request listing control, the user interface 500 can present a list of collaborative projects of the user that are pending for approval by their designated collaborative project approvers. The collaborative project control menu 504 can include a collaborative project listing control. When the user of the user device 120a activates the collaborative project listing control, the user interface 500 can present a list of collaborative projects of the user that have been approved by their designated collaborative project approvers. In some embodiments, the collaborative project control menu 504 can allow assigning to the collaborative project at least one of a project leader and an expiration date.

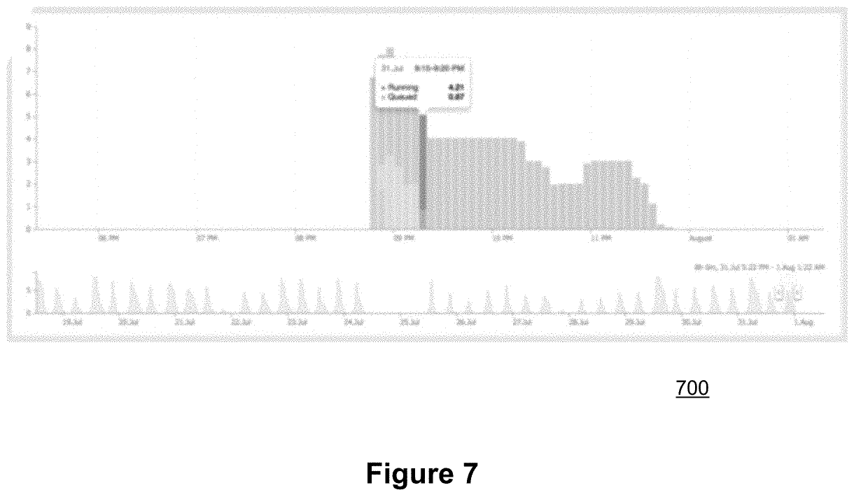

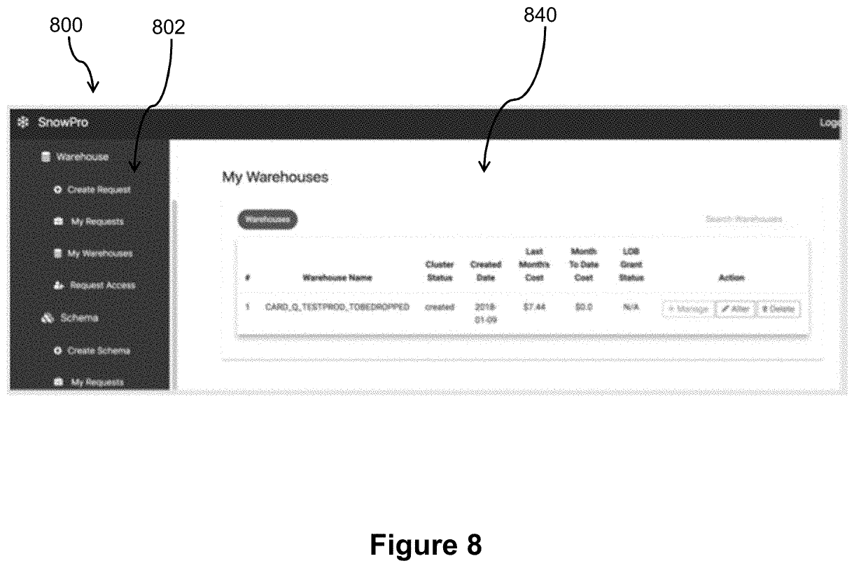

FIGS. 6-8 illustrate user interfaces generated for improving provisioning of compute and data resources among multiple users by the system 100 of FIG. 1, according to some embodiments of the present disclosure. As shown in FIG. 6, the user interface 600 illustrates a list of virtual warehouse names, a date of creation, number of days left for the virtual warehouse, a virtual warehouse requestor identifier, a virtual warehouse approver identifier, and a list of permitted data types (e.g. NPI, Credit, API, Affiliate, etc.). As shown in FIG. 7, the user interface 700 illustrates a real-time provisioning of compute resources (e.g. warehouses) performed by the system 100 of FIG. 1. The user interface 700 shows the provisioning of warehouses performed by managing the work flows of request, approval, and creation, enforcing the expiration and dropping of the collaboration schemas at the end of a specific time period and managing the extension request, logging and reporting of all collaboration schemas to public. As shown in FIG. 8, the user interface 800 illustrates a screenshot including compute resources provisioned by the system 100 of FIG. 1. The user interface 800 displays a warehouse with a warehouse name CARD_Q_TESTPROD_TOBEDROPPED created on 09-01-2018 and having a last month's cost of $7.44. The user interface 800 provides the option of enforcing the expiration and dropping of the collaboration schema at the end of a specific time period.

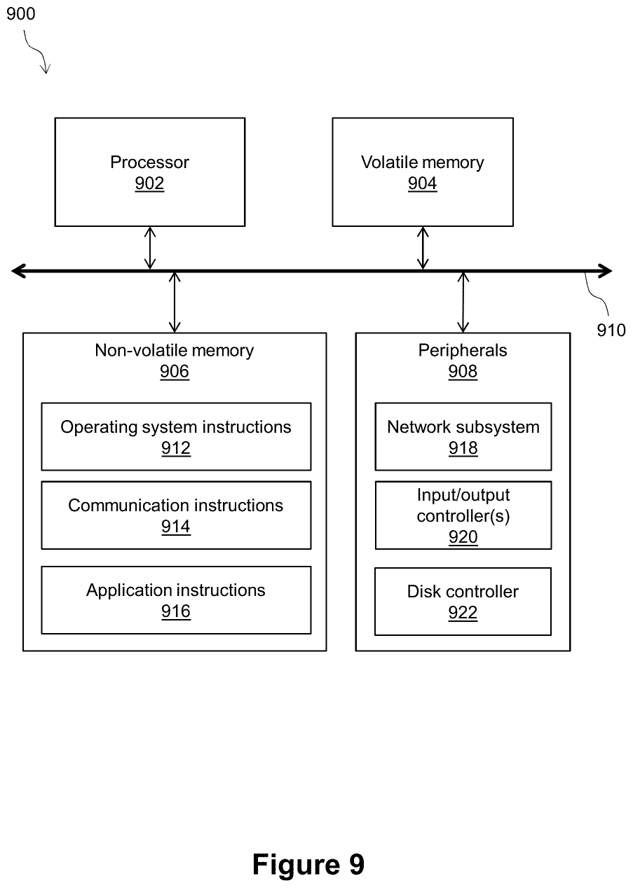

FIG. 9 is a block diagram of an example user device 900 that can perform at least part of the processing described herein, according to an embodiment of the present disclosure. User device 900 may include a processor 902, a volatile memory 904, a non-volatile memory 906 (e.g., hard disk), and peripherals 908, each of which is coupled together by a bus 910. Non-volatile memory 906 may be configured to store computer instructions 912, operating system 914, and data 916. In one example, computer instructions 912 are executed by the processor 902 out of the volatile memory 904. In some embodiments, the user device 900 corresponds to a virtual machine. In other embodiments, user device 900 corresponds to a physical computer.

Referring again to FIG. 9, processing may be implemented in hardware, software, or a combination of the two. In various embodiments, processing is provided by computer programs executing on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

### Conclusion

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate. The program logic may be run on a physical or virtual processor. The program logic may be run across one or more physical or virtual processors.

Processing may be performed by one or more programmable processors executing one or more computer programs to perform the functions of the system. All or part of the system may be implemented as special purpose logic circuitry (e.g., an FPGA (field programmable gate array) and/or an ASIC (application-specific integrated circuit)).

Additionally, the software included as part of the concepts, structures, and techniques sought to be protected herein may be embodied in a computer program product that includes a computer-readable storage medium. For example, such a computer-readable storage medium can include a computer-readable memory device, such as a hard drive device, a CD-ROM, a DVD-ROM, or a computer diskette, having computer-readable program code segments stored thereon. In contrast, a computer-readable transmission medium can include a communications link, either optical, wired, or wireless, having program code segments carried thereon as digital or analog signals. A non-transitory machine-readable medium may include but is not limited to a hard drive, compact disc, flash memory, non-volatile memory, volatile memory, magnetic diskette, and so forth but does not include a transitory signal per se. In describing exemplary embodiments, specific terminology is used for the sake of clarity. For purposes of description, each specific term is intended to at least include all technical and functional equivalents that operate in a similar manner to accomplish a similar purpose.

Additionally, in some instances where a particular exemplary embodiment includes a plurality of system elements, device components or method steps, those elements, components or steps may be replaced with a single element, component, or step. Likewise, a single element, component, or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

1. A method for improving provisioning of compute resources among multiple users, the method comprising
presenting, on a display of a computing device, a user interface (UI) for provisioning compute resources within an elastic data warehouse system comprising one or more virtual warehouses, wherein the UI comprises a virtual warehouse control menu and a virtual warehouse creation form;
receiving, in response to a user submitting information via the virtual warehouse creation form, a virtual warehouse name, a virtual warehouse specification, constraints on a running cluster count, and a virtual warehouse approver identifier;
sending the virtual warehouse name, the virtual warehouse specification, constraints on the running cluster count, and the virtual warehouse approver identifier to a provisioning server;
receiving from the provisioning server a validation result for the virtual warehouse name, a cost estimate based on the virtual warehouse specification and the constraints on the running cluster count, and a verification result for the virtual warehouse approver identifier; and
displaying, on the virtual warehouse creation form, the validation result, the cost estimate, and the verification result, and
wherein the provisioning server is configured to use the virtual warehouse name, the virtual warehouse specification, the constraints on the running cluster count, and the virtual warehouse approver identifier to provision the compute resources within the elastic data warehouse system.

2. The method of claim 1, wherein receiving the validation result for the virtual warehouse name, the cost estimate based on the virtual warehouse specification, and the verification result for the virtual warehouse approver identifier is asynchronous.

3. The method of claim 2, wherein the UI further comprises a request submission control, and wherein the method further comprises sending a virtual warehouse request to the provisioning server in response to the user activating the request submission control.

4. The method of claim 2, wherein the virtual warehouse control menu comprises a request listing control, and wherein the method further comprises, in response to the user activating the request listing control, presenting a list of virtual warehouses of the user that are pending for approval by their designated virtual warehouse approvers.

5. The method of claim 2, wherein the virtual warehouse control menu comprises a virtual warehouse listing control, and wherein the method further comprises, in response to the user activating the virtual warehouse listing control, presenting a list of virtual warehouses of the user that have been approved by their designated virtual warehouse approvers.

6. The method of claim 2, further comprising:
presenting, on the display of the computing device, the UI that further comprises a collaborative project control menu and a collaborative project creation form, each for a collaborative project of two or more users of the compute resources;
receiving, in response to a user submitting information via the collaborative project creation form, a collaborative project name, a collaborative project data type, and a collaborative project approver identifier;
sending the collaborative project name, the collaborative project data type, and the collaborative project approver identifier to the provisioning server;
receiving from the provisioning server a project validation result for the collaborative project name, a project authorization result based on the collaborative project data type, and a project verification result for the collaborative project approver identifier; and
displaying, on the virtual warehouse creation form, the project validation result, the project authorization result, and the project verification result.

7. The method of claim 6, wherein the UI further comprises a project request submission control, and wherein the method further comprises sending a collaborative project request to the provisioning server in response to the user activating the project request submission control.

8. The method of claim 6, wherein the collaborative project control menu comprises a project request listing control, and wherein the method further comprises, in response to the user activating the project request listing control, presenting a list of collaborative projects of the user that are pending for approval by their designated collaborative project approvers.

9. The method of claim 6, wherein the collaborative project control menu comprises a collaborative project listing control, and wherein the method further comprises, in response to the user activating the collaborative project listing control, presenting a list of collaborative projects of the user that have been approved by their designated collaborative project approvers.

10. A method for improving provisioning of compute resources among multiple users, the method comprising:
receiving, from a computing device configured for provisioning compute resources within an elastic data warehouse system comprising one or more virtual warehouses, a virtual warehouse name, a virtual warehouse specification, constraints on a running cluster count, and a virtual warehouse approver identifier;
determining, by a validation module, a validation result for the virtual warehouse name by analyzing the virtual warehouse name for its conformance to a naming standards ruleset, wherein the validation result comprises valid and invalid;
determining, by an estimation module, a cost estimate based on the virtual warehouse specification and the constraints on the running cluster count, by using the virtual warehouse specification and the constraints on the running cluster count in a cost estimator model;
determining, by a verification module, a verification result for the virtual warehouse approver identifier by comparing the virtual warehouse approver identifier to entries in a provisioning approver identifier list;
sending the validation result, the cost estimate, and the verification result to the computing device; and
provisioning the compute resources within the elastic data warehouse system by using the virtual warehouse name, the virtual warehouse specification, constraints on the running cluster count, and the virtual warehouse approver identifier.

11. The method of claim 10, wherein each of receiving of the virtual warehouse name, the virtual warehouse specification, and the virtual warehouse approver identifier, and sending of the validation result, the cost estimate, and the verification result is asynchronous.

12. The method of claim 11, further comprising, in response to receiving a virtual warehouse request from the computing device, sending a virtual warehouse approval request to an approver computing device associated with a virtual warehouse approver designated by the virtual warehouse approver identifier.

13. The method of claim 12, further comprising, receiving an approval from the approver computing device before provisioning the compute resources within the elastic data warehouse system.

14. The method of claim 13, further comprising, monitoring an actual cost and an actual workload of a virtual warehouse of the elastic data warehouse system.

15. The method of claim 11, further comprising, in response to receiving a request listing inquiry from the computing device, sending to the computing device a list of virtual warehouses of the user that are pending for approval by their designated virtual warehouse approvers.

16. The method of claim 11, further comprising, in response to receiving a virtual warehouse listing request from the computing device, sending to the computing device a list of virtual warehouses of the user that have been approved by their designated virtual warehouse approvers.

17. The method of claim 11, further comprising:
receiving, from the computing device, a collaborative project name, a collaborative project data type, and a collaborative project approver identifier, each for a collaborative project of two or more users of the compute resources;
determining, by a validation module, a project validation result for the collaborative project name by analyzing the collaborative project name for its conformance to a project naming standards ruleset;
determining, by an estimation module, a project authorization result based on the collaborative project data type by comparing the collaborative project data type with a list of permitted data types for project users of the collaborative project;
determining, by a verification module, a project verification result for the collaborative project approver identifier by comparing the collaborative project approver identifier to entries in a project provisioning approver identifier list; and
sending the project validation result, the project authorization result, and the project verification result to the computing device.

18. The method of claim 17, further comprising:
assigning a project leader for the collaborative project.

19. The method of claim 17, further comprising:
assigning an expiration date for the collaborative project.

20. A system for improving provisioning of compute resources among multiple users, the system comprising
a database;
one or more processors;
a managing module configured for execution by the one or more processors to:
receive, from a computing device configured for provisioning compute resources within an elastic data warehouse system comprising one or more virtual warehouses, one or more input parameters;
send the one or more input parameters to one or more modules, wherein the one or more modules are selected from the group consisting of a validation module, an estimation module, and a verification module;
receive one or more output parameters from the one or more modules;
send the one or more output parameters to the computing device; and
provision the compute resources within the elastic data warehouse system by using the one or more output parameters;
the validation module configured for execution by the one or more processors to:
receive a virtual warehouse name from the managing module;
determine the validation result for the virtual warehouse name by analyzing the virtual warehouse name for its conformance to a naming standards ruleset; and
send the validation result to the managing module;
the estimation module configured for execution by the one or more processors to:
receive a virtual warehouse specification and constraints on a running cluster count from the managing module;
determine the cost estimate based on the virtual warehouse specification and constraints on the running cluster count by using the virtual warehouse specification and constraints on the running cluster count in a cost estimator model; and
send the cost estimate to the managing module; and
the verification module configured for execution by the one or more processors to:
receive a virtual warehouse approver identifier parameter from the managing module;
determine the verification result for the virtual warehouse approver identifier by comparing the virtual warehouse approver identifier to entries in a provisioning approver identifier list; and
send the verification result to the managing module.
